(19) United States
(12) Patent Application Publication
(10) Pub. No.: US 2009/0019068 A1
(43) Pub. Date: Jan. 15, 2009

(54) DECODER WITH REDUCED MEMORY REQUIREMENTS DECODING OF VIDEO SIGNALS

(75) Inventors: YANBIN YU, FREMONT, CA (US); Johannes Wang, REDWOOD CITY, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/775,208

(22) Filed: Jul. 9, 2007

(51) Int. Cl. G06F 7/00; G06F 17/30

(52) U.S. Cl. 707/101; 707/E17.009

(57) ABSTRACT

A decoder decoding at a block level provided. The decoder comprises: a down-scalar receiving a multiplicity of blocks of data and down-scaling the blocks of data at the block level and storing the down-scaled data in a memory; and an output device for outputting the down-scaled blocks of data at the block level.

### CROSS-REFERENCE TO OTHER APPLICATIONS

The following applications of common assignee are related to the present application, and are herein incorporated by reference in their entireties: “METHOD AND APPARATUS FOR REDUCED MEMORY DECODING OF VIDEO SIGNALS” Ser. No. ______, filed [date herein], Attorney Docket No. LSFFT-078.

### FIELD OF THE INVENTION

The present invention relates generally to video display, more specifically the present invention relates to method and apparatus for reduced memory decoding of video signals.

### BACKGROUND

In digital program signal decoding such as the MPEG decoding, in particular, HD (High Definition) type decoding, the demand for memory bandwidth is very high as compared with the lower resolution types. For example, MPEG-II at the 1080i (Main Profile at high Level), the motion compensation operations need at least 400 megabytes per second (Mbytes/s) for the worst case scenario (i.e. the requirement for a safe design).

However, in some applications, the final requisite presentation image resolution is not as high as the incoming bit stream. For example, the presentation resolution can be 720×480 even though the input bitstream has higher resolution than 720×480 thereby taking up more bandwidth. Furthermore, in the mobile applications, the presentation resolution can be even lower, say, 360×240. In the meantime, the power consumption requirement is much tighter in mobile applications. Therefore, any intermediately processing that can be eliminated helps.

Traditional decoding method and apparatus decodes the bitstream with full resolution. The decoding process then scales the image into final presentation solutions. As can be seen, the required memory bandwidth is high as well as demanding in that for HD decoding if conducted with full resolutions.

It is therefore desirable to devise a decoding apparatus and method with much less memory access requirement for such applications than the full resolution decoding.

### SUMMARY OF THE INVENTION

In an audio/video (A/V) system, the display image size is reduced to save memory size and bandwidth.

In an audio/video (A/V) system, the display image size is reduced on the block level to save memory size and bandwidth.

In an audio/video (A/V) system, the display image size is reduced on the block level to save memory size and bandwidth.

In an audio/video (A/V) system, the display image size is reduced on the block level to save memory size and bandwidth (e.g. memory access), while still maintaining a predetermined final display resolution and quality.

In mobile communication systems, the display image size is reduced to save memory size and bandwidth.

In mobile communication systems, the display image size is reduced on the block level to save memory size and bandwidth.

In mobile communication systems, the display image size is reduced on the block level to save memory size and bandwidth.

In mobile communication systems, the display image size is reduced on the block level to save memory size and bandwidth (e.g. memory access), while still maintaining a predetermined final display resolution and quality.

A decoder decoding at a block level provided. The decoder comprises: a down-scalar receiving a multiplicity of blocks of data and down-scaling the blocks of data at the block level and storing the down-scaled data in a memory; and an output device for outputting the down-scaled blocks of data at the block level.

A receiver having a decoder decoding at a block level provided. The decoder comprises: a down-scalar receiving a multiplicity of blocks of data and down-scaling the blocks of data at the block level and storing the down-scaled data in a memory; and an output device for outputting the down-scaled blocks of data at the block level.

The purpose of this invention is to optimize the memory access and therefore memory bandwidth requirements, while maintaining an acceptable the final display resolution and quality. In the meantime the system costs and power consumption will be substantially reduced.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a prior art system.

FIG. 2 is an example of a preferred embodiment n accordance with some embodiments of the invention.

FIG. 3 is an example of an alternative embodiment in accordance with some embodiments of the invention.

FIG. 3 is an example of Macro Block (MB) structure in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to reduce display image size on the block level to save memory size and bandwidth. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of reduce display image size on the block level to save memory size and bandwidth described herein. The non-processor circuits may include, but are not limited to, a radio receiver, a radio transmitter, signal drivers, clock circuits, power source circuits, and user input devices. As such, these functions may be interpreted as steps of a method to perform reduce display image size on the block level to save memory size and bandwidth. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

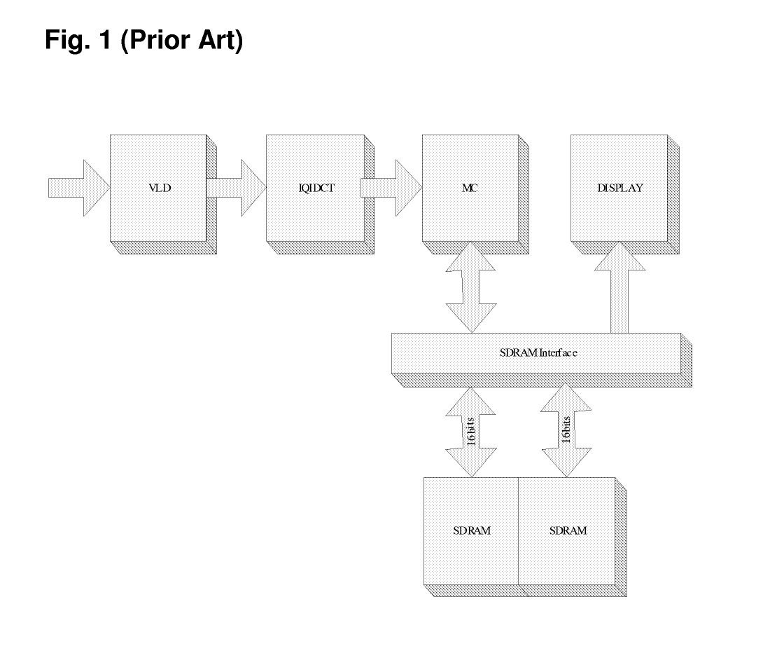

Referring to FIG. 1, a typical, prior art, normal MPEG decoding system is shown. For the typical MPEC decoding system, the incoming bitstream is parsed by the VLD (Variable Length Code Decoder) first to derive out the DCT coefficients. The amplitudes of the coefficients are scaled using QP (Quantization Parameter) and then are fed into IDCT (Inverse Discrete Cosine Transform) module. For an I (Intra) picture, the data is just down-scaled into a proper size and format and, in turn, is saved into a SDRAM for further use. For the P (Predicted) and B (Bi-directional predicted) picture data, if motion compensated mode is activated, the reference data is fetched from SDRAM and scaled into original size and motion compensated operations are performed. After motion compensation operations, the result is scaled into a predetermined size and format, which can be the same as that of I picture data. Since down-scaled data can have ½ or even ¼ of the original size, the memory bandwidth is therefore reduced as the result. For example, if the horizontal number of pixel is 720 for SD (Standard Definition) display, whereas the incoming bitstream will produce some 1920 pixels. By simply scaled down to half to 860 pixels, the memory bandwidth requirement will be proportionally reduced as well.

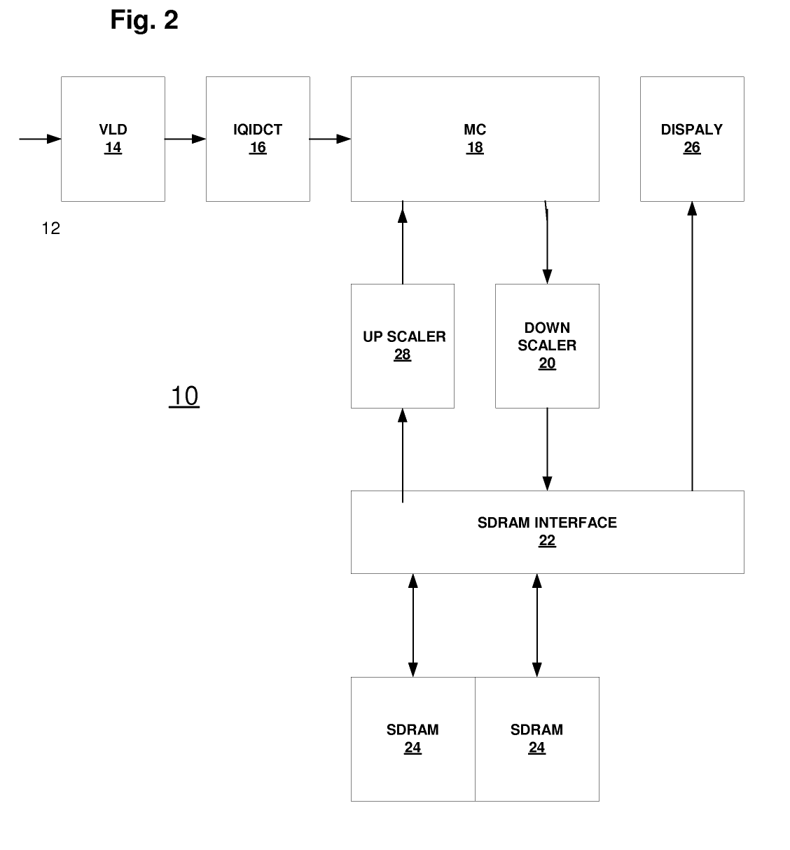

Referring to FIG. 2, a System Block diagram of an exemplified embodiment can be depicted as follows: the incoming data stream 12 is subjected to variable length code decoder (VLD) 14. The decoded data stream 12 is further subjected inverse transformation 16 such as inverse Q/I discrete cosine transformation (IQIDCT). As can be seen, the first half of the system i.e. the VLD 14 and IQ/IDCT 16 is the same as a traditional MPEG video decoding system as shown in FIG. 1. The transformed, output data from IQ/IDCT module 16 is fed into a MC (Motion Compensation) Module 18. The motion compensation operations are conducted in the original, incoming resolution domain at the mega block (MB) level. The MBs are respectively down-scaled by down-scaler 20. The done-scaled data structure at the mega-block level (in low resolution for display purposes) is processed by memory interface 22. The processed, done-scaled data structure is further processed by memory interface 22. At this juncture, data either stored in memory 24, or sent to display 26 for displaying. memory interface 22 also selects data for displaying from memory 24. An 28 is interposed or coupled between motion compensation (MC) block 18 and memory interface 22 for possible or optional up-scalling.

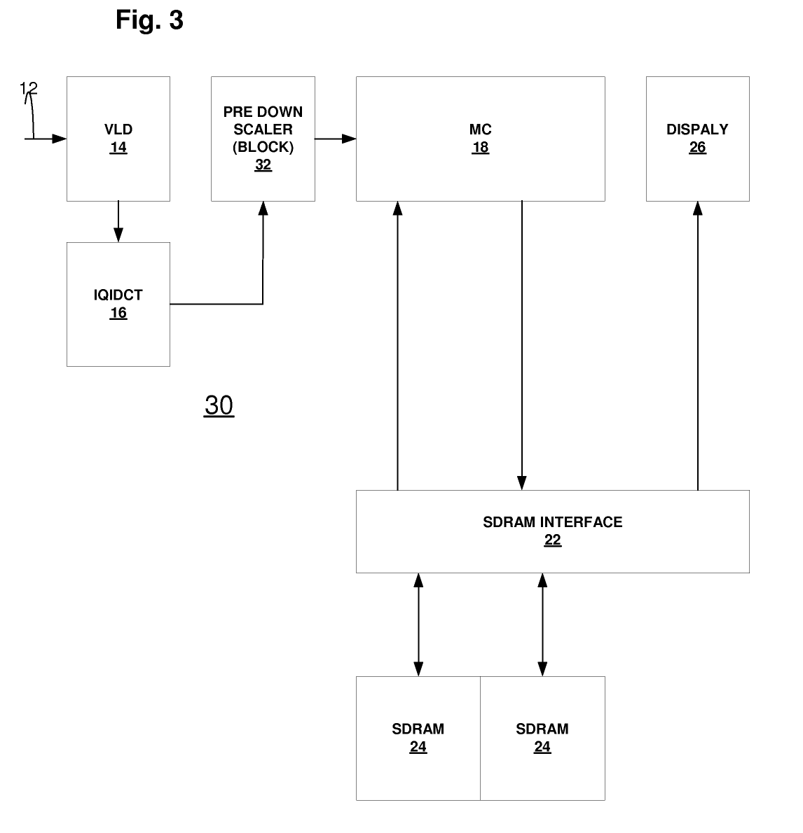

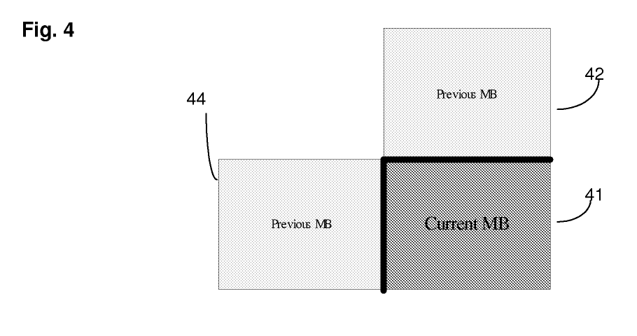

Referring to FIG. 3, an alternative embodiment 30 of the present invention is shown. In the alternative embodiment 30, pre-down scaling is performed before motion compensation (MC) 18. In addition, the optional 28 and down-scaler 20 is eliminated. In other words, the incoming data stream 12 is subjected to variable length code decoder (VLD) 14. The decoded data stream 12 is further subjected inverse transformation 16 such as IQIDCT. As can be seen, the first half of the system i.e. the VLD 14 and IQ/IDCT 16 is the same as a traditional MPEG video decoding system as shown in FIG. 1. The transformed, output data from IQ/IDCT module 16 is first subjected to pre down scaler 32 at the MB level and then fed into a MC (Motion Compensation) Module 18. These motion compensation operations are not conducted in the original, incoming resolution domain at the mega block (MB) level. Instead, motion compensation operations are done at a reduced resolution domain that is suitable for display by display 26. The done-scaled data structure at the mega-block level (in low resolution for display purposes) is processed by memory interface 22. The processed, done-scaled data structure is further processed by memory interface 22. At this juncture, data either stored in memory 24, or sent to display 26 for displaying. memory interface 22 also selects data for displaying from memory 24.

MPEG or MPEG-like video systems use the MB (Macro-Block) data structure. Since MPEG or MPEG-like video compression algorithms make use or take advantage of MB (Macro-Block) data structure, the down-scaling and up-scaling operations are difficult to be performed over the whole scanning line either in horizontal direction, or between the MBs in the vertical direction. Furthermore, the smooth scaling must be perform during decoding period of the session but not in the final display stage as usually referred as de-blocking filter. A typical de-blocking filter, such as defined in the H.264 algorithm, will increase the memory bandwidth and therefore are not suitable for this application. Therefore, after the original, non-connected MB is selected, a novel method or device is required such that both memory bandwidth is reduced and block effect reduced to an acceptable level.

the new method called “Over lapped Recursive 2-D Scaling” 40 is devised to overcome the scaling difficulties without increasing the memory bandwidth. In method 40, if the I (Intra) picture is the current picture, the data is sent back to SDRAM for further processing like MC 18 for the other pictures and final display. An OLRS (Over Lapped Recursive Scaling) method 40 is used to scale the data into smaller MB before the data being sent to SDRAM Interface 22. If P or B pictures are being decoded, the reference picture data like I or P picture data, in smaller MB format, are fetched from SDRAM 24. They are scaled up to the original resolutions using OLRS methods 40. The MC (Motion Compensation) 18 operation is performed together with the result of IDCT 16 in the original resolutions. The resultant data is scaled down using OLRS 40, similar to the I picture data, and sent back to SDRAM 24 for display 26.

The detailed descriptions of Over Lapped Recursive 2-D Scaling (OLRS) Operations 40 are shown as follows:

Referring to FIG. 4, the figure below shows the Macro Block (MB) structure of a MPEG-like video coding algorithms. The decoding is performed on each MB at a time and in a way from either left to right, or from top to bottom. For a current processed MB 41, it has one upper previously coded MB 42 and one left previously coded MB 44.

The present invention contemplates applications in a TDS-OFDM system or receiver. U.S. patent application entitled “Receiver Structure for an LDPC-Based TDS-OFDM Communication System” Ser. No. 11/740,712, filed Apr. 26, 2007, Attorney Docket No. LSC-P016 is hereby incorporated herein by reference.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A decoder decoding at a block level, comprising:
a down-scalar receiving a multiplicity of blocks of data and down-scaling the blocks of data at the block level and storing the down-scaled data in a memory; and
an output device for outputting the down-scaled blocks of data at the block level.

2. The decoder of claim 1, wherein the down-scaled blocks of data is either stored in the memory and then outputted, or immediately outputted upon down scaling.

3. The decoder of claim 1, wherein the block comprising a mega-block data structure.

4. The decoder of claim 1, wherein the output device comprises a video display.

5. A digital receiver comprising:
a decoder comprising:
a down-scalar receiving a multiplicity of blocks of data and down-scaling the blocks of data at the block level and storing the down-scaled data in a memory; and
an output device for outputting the down-scaled blocks of data at the block level.

6. The digital receiver of claim 5, wherein the down-scaled blocks of data is either stored in the memory and then outputted, or immediately outputted upon down scaling.

7. The digital receiver of claim 5, wherein the block comprising a mega-block data structure.

8. The digital receiver of claim 5, wherein the output device comprises a video display.

9. A method for decoding at a block level, comprising the steps of:
receiving a multiplicity of blocks of data;
down-scaling the blocks of data at the block level;
storing the down-scaled data in a memory; and
outputting the down-scaled blocks of data at the block level to an output device.

10. The method of claim 9, wherein the down-scaled blocks of data is either stored in the memory and then outputted, or immediately outputted upon down scaling.

11. The method of claim 9, wherein the block comprising a mega-block data structure.

12. The method of claim 9, wherein the output device comprises a video display.
